(19) United States
(12) Patent Application Publication
(10) Pub. No.: US 2005/0108252 A1
(43) Pub. Date: May 19, 2005

(54) Incremental process system and computer useable medium for extracting logical implications from relational data based on generators and faces of closed sets

(76) Inventors: John L Pfaltz, Charlottesville, VA (US); Christopher M. Taylor, Manakin-Sabot, VA (US); Robert E. Jamison, Central, SC (US)

Correspondence Address: UNIVERSITY OF VIRGINIA PATENT FOUNDATION, 1224 WEST MAIN STREET, SUITE 1-110, CHARLOTTESVILLE, VA, 22903, US

(21) Appl. No.: 10/508,278

(22) PCT Filed: Mar. 19, 2003
(86) PCT No.: PCT/US03/08833

Related U.S. Application Data
(60) Provisional application No. 60/365,495, filed on Mar. 19, 2002.
(60) Provisional application No. 60/371,503, filed on Apr. 10, 2002.

(51) Int. Cl. G06F 7/00

(52) U.S. Cl. 707/100

(57) ABSTRACT

A method, system, and computer useable medium for exploring logical implications of attributes of interest based on a relational data set, R, is described. The related method, system and computer medium comprises receiving attributes and observations (12, 14, 16, 18, 20, 22, 24, 26, 28) which form the relational data set, R, creating a database correlating the attributes and observations (12, 14, 16, 18, 20, 22, 24, 26, 28), forming a lattice structure (10) from the data in the database, identifying closed sets of attributes within the lattice structure and identifying attributes that are minimal generators (30, 32, 34, 36) of the relational data.

### CROSS REFERENCE TO RELATED APPLICATIONS

This application claims the benefit of U.S. Provisional Application No. 60/365,495, filed Mar. 19, 2002 and U.S. Provisional Application No. 60/371,503, filed Apr. 10, 2002 which are hereby incorporated by reference in its entirety.

### STATEMENT REGARDING FEDERALLY SPONSORED RESEARCH & DEVELOPMENT

The United States Government has acquired certain rights in this invention pursuant to DOE Grant No. DEFG02-95ER25254 issued by the Department of Energy.

### BACKGROUND OF THE INVENTION

This invention relates generally to analysis of data, and more specifically to methods and systems for extracting logical implications from relational data.

Formal concept analysis is a process by which information contained in relational data is collected into concepts, and the relationships between concepts is represented by a concept lattice. In one known approach of formal concept analysis, concept lattices are visually analyzed for apparent relationships. However, it is also known that processes based on visual analysis fail when, for example, more than 100 concepts are to be displayed.

Data mining is a popular term for the extraction of statistical and other associations from massive amounts of relational data. One practical solution was the “a priori” method, which has since been refined by many others. In the “a priori” method, an association is an assertion of the form “the presence of A frequently implies the presence of B”. The meaning of “frequently” is a parameter set by a user. This statistical approach has been widely used in market-basket analysis of point-of-sale data

Concept lattices have been applied to data mining as a mechanism for eliminating certain kinds of trivial associations and accelerating the data mining process.

One problem that has yet to be confronted is that computation of large concept lattices along with their generators is computationally impractical. The addition of new data results in well-structured, local changes to the concept lattice. However, conventional methods required recalculation of the entire concept lattice in order to specify the local changes.

### BRIEF DESCRIPTION OF THE INVENTION

In accordance with one embodiment of the present invention, a method is provided for exploring logical implications of attributes of interest within a relational data set, R. The method comprises receiving attributes columns and observations row which form the relational data set, R, creating a database correlating the attributes and observations, forming a lattice structure from the data in the database, identifying closed sets of attributes within the lattice structure, and identifying attributes that are minimal generators of the relational data.

In accordance with another embodiment of the present invention, a computer system is provided. The computer system comprises memory storing relational data, the relational data including a set of attributes and observations, a processor forming a lattice structure from the attributes and observations, identifying closed sets of attributes within the lattice structure, and identifying attributes that are minimal generators of the lattice structure, and a display unit presenting the minimal generators, the minimal generators being a set of logical implications of attributes identified as the minimal generators of the lattice structure.

In accordance with still another embodiment of the present invention, a computer program embodied on a computer-readable medium is provided. The computer program determines minimal generators of a lattice structure of relational data which includes observations and attributes of the observations, and determines changes to the minimal generators of the lattice structure resulting from iterative addition of observations to the relational data. The computer program comprises a source code segment forming the lattice structure from the relational data, and incrementally changing the lattice structure based on each observation to be added to the lattice structure, a set identification source code segment identifying closed sets of attributes from the observations within the lattice structure, and a minimal generator identification source code segment identifying attributes that are minimal generators of the lattice structure.

In accordance with yet another embodiment of the present invention, a method for finding all causal dependencies between data items in a relational data set of observations and attributes of the observations, independent of the frequency of those observations is provided. The method comprises determining intersections between the observations, the intersections and observations being closed sets of attributes, forming logical implications based on the closed sets, and determining changes to the implications based on changes to the intersections resulting from additional observations.

### BRIEF DESCRIPTION OF THE DRAWINGS

FIG. 1 illustrates an exemplary partial concept lattice showing minimal generators of two concepts within the lattice.

FIG. 2 illustrates the concept lattice of FIG. 1 with an additional concept entered and the resulting changes in minimal generators.

FIG. 3 illustrates a pseudo-program illustrating a process carried out in accordance with an embodiment of the present invention.

FIG. 4 illustrates a computer system configured to operate in accordance with an embodiment of the present invention.

FIG. 5 illustrates an example relational data set utilized to illustrate an embodiment of the present invention.

FIG. 6 illustrates a portion of a concept lattice generated from the first row of relational data of FIG. 5, as indicated in lower right portion of FIG. 5.

FIG. 7 illustrates an observation of the concept lattice being added to the portion shown in FIG. 6, including identification of a minimal generator of the observation.

FIG. 8 illustrates another observation being added to the concept lattice of FIG. 7, including identification of a minimal generator of the observation.

FIG. 9 illustrates identification of an intersection between observations being added to the concept lattice of FIG. 8.

FIG. 10 illustrates a change in the minimal generators of an observation based on the intersection identification of FIG. 9.

FIG. 11 illustrates an additional minimal generator identification.

FIG. 12 illustrates identification of an intersection between the intersection identified in FIG. 9 and one of the observations.

FIG. 13 illustrates identification of another intersection between the intersection identified in FIG. 9 and the observation of FIG. 6, and the resulting change in the minimal generators.

FIG. 14 illustrates the concept lattice generated by the relational data set of FIG. 5, including identification of the minimal generators of the lattice.

FIG. 15 illustrates the implications yielded by the single generators of a binary relation, R with 8124 rows and 42 attributes, or columns.

FIG. 16 illustrates the implications corresponding to “poisonous” in the mushroom data set.

FIG. 17 illustrates the implications corresponding to “edible” in the mushroom data set.

The foregoing summary, as well as the following detailed description of certain embodiments of the present invention, will be better understood when read in conjunction with the appended drawings. It should be understood, however, that the present invention is not limited to the precise arrangements and instrumentality shown in the attached drawings.

### DETAILED DESCRIPTION OF THE INVENTION

Below described are methods, computer readable medium and systems which provide closed set data mining, which operates in an iterative fashion, and may be utilized when the data to be analyzed is dense and deterministic. The methods emulate scientific empirical induction in a closed set paradigm. Such data mining can serve as a data source for rule based systems, and can facilitate deduction.

In one embodiment, a process and system which finds logical implications of the form “A implies B” (A→B) inherent in a relational data set D is provided. Unlike standard data mining procedures, the process is not statistically based, all logical implications are uncovered, no matter how frequent or how rare, and the data set, D, need not be fixed. D may be a continuing stream of observations.

For these reasons, the described system is able to draw logical conclusions from a sequence of observations resulting from scientific, research experimentation or from any other data gathering process. The resulting logical output A→B, is then utilized as inputs, in one example, to rule based artificial intelligence (AI) systems. For this reason, the described processes and systems embodying the processes have been proposed as a way of transforming the sensory observations of a robot to rules for the robot's planning component.

First, a general explanation is provided of a method for extracting logical implications from relational data. A real world object, or a scientific observation, o, is described by a collection of attributes, or properties, a₁, a₂, . . . aₙ, which are denoted by o.α. The same enumeration of attributes would be called a tuple, or row, in relational data theory and called a transaction when data mining in a market basket application. The universe of all possible attributes are denoted by A, and the collection of all observations are denoted by O. The collection O of all observations, tuples, or objects together with each o.α are normally called a relation R, or a data set D.

A concept cᵢ includes a set of attributes Aᵢ⊂A and a set of objects, or observations, Oᵢ⊂O. That is, concept cᵢ=(Aᵢ, Oᵢ). Each individual observation o∈Oᵢ exhibits every attribute α∈Aᵢ and there are no other attributes, or properties, common to all the observations. There are no other observations recording all of the attributes. That is, Aᵢ and Oᵢ are maximal closed subsets. A concept lattice L includes all possible concepts, Cᵢ, derivable from D. In this lattice L, cᵢ=(Aᵢ, Oᵢ)≦cₖ=(Aₖ, Oₖ) if and only if Aᵢ⊂Aₖ, or equivalently Oₖ⊂Oᵢ. The difference Aₖ−Aᵢ is called a face of Aₖ.

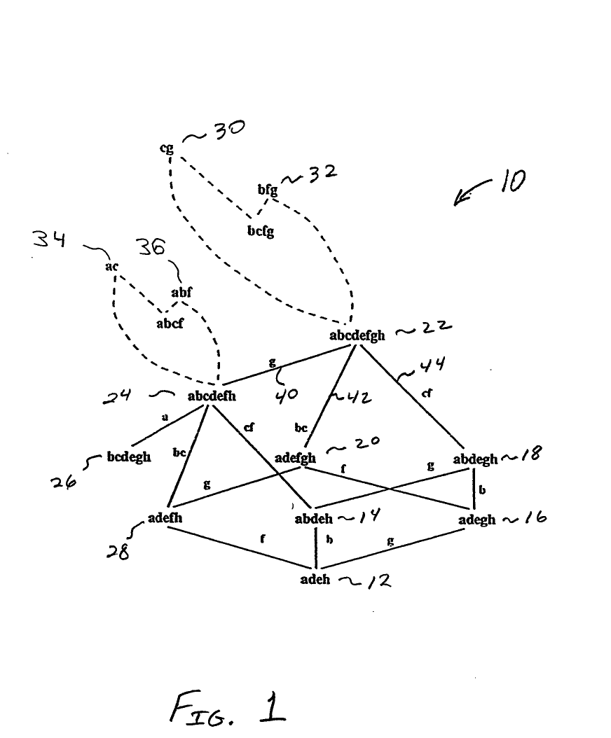

Cᵢ=(Aᵢ, Oᵢ) is a mathematical representation of a concept. Aᵢ=a₁, a₂, . . . a₈. Since Aᵢ is a closed set it has one, or more, generating sets, for example, a₃, a₇ and a₂, a₆, a₇ in FIG. 1. As concepts are defined, it is clear that any object with properties a₃ and a₇, or with a₂, a₆ and a₇ must also have properties a₁, . . . a₈. In the formal notation of logic, that is
(∀o∈O)[((a₃ [symbol] a₇) [symbol] (a₂ [symbol] a₆ [symbol] a₇))→(a₁ [symbol] a₂ [symbol] . . . [symbol] a₈)].

Several evaluation methods exist for determining the information content and importance of the implication represented by a single concept. Each concept in the lattice is evaluated, and “interesting” concepts are flagged. Typically these evaluation methods are designed for a particular application domain.

The generating sets {a₃, a₇} and {a₂, a₆, a₇} constitute the minimal precedents of any logical implication whose consequent is a₁, a₂, . . . a₈. However, a local structure of the lattice is also described.

For example, a correspondence between generators and faces, as further described below, requires faces of the cᵢ example to be {a₇}, {a₂, a₃} and {a₃, a₆}. Consequently, the concept cᵢ covers the three concepts cᵢ_{₁}=({a₁, . . . a₆,a₈},Oᵢ_{₁}),cᵢ_{₂}=({a₁,a₄ . . . a₈},Oₗ_{₂}), and cᵢ_{₃}=({a₁,a₂,a₄,a₅,a₇,a₈},Oᵢ_{₃}) It has been determined that, for every new observation, o′, if its attribute set o′.α is not already closed in L, it must be covered by some concept cᵢ, whose generating set can then be adjusted accordingly and because closed sets are closed under intersection, adding a concept c′=(o′.α,o′) may recursively induce more concepts to be added to L, but only because of intersection with other concepts below cᵢ. Transformation of L tends to be localized and small.

The kind of adjustments for every new observation is best illustrated by example. Assume a new observation o′ with attributes o′.α={a₁,a₃,a₄,a₅,a₇,a₈} giving rise to a new concept cₖ. Since cₖ≦cᵢ,{a₂,a₆} is a new face. Consequently, the generators of concept cᵢ must be adjusted to reflect the new observation o′. The attribute set {a₃,a₇} can no longer be a minimal generator of concept cᵢ, but {a₂,a₃,a₇} is. Since the universe O of observations has changed, the logical assertion made above is no longer valid, and is changed to
(∀o∈O)[((a₂ [symbol] a₃ [symbol] a₇) [symbol] (a₂ [symbol] a₆ [symbol] a₇))→(a₁ [symbol] a₂ [symbol] . . . [symbol] a₈)].

As observations about a particular universe of phenomena change, any logical description of that universe will change as well. The methods and systems described herein provide this incremental capability. In addition, many identical observations will be repeated over and over again and thus it may be desirable to keep a record of observations supporting each concept, as well as each logical assertion. For example, a concept cᵢ has been supported by hundreds of observations. However, a new observation may be received that causes a change to the generators of the concept cᵢ. A real world example in a study of animal species provides the attributes a₁≡“nurses its young” and a₂≡“gives live birth”. The resulting logical implication a₁→a₂ (i.e., if a species nurses its young, this implies that it gives live birth) is supported by thousands of observations, until a duck-billed platypus is encountered. The new observation is examined carefully to ensure there wasn't an error. Then, if convinced of its validity, the occurrence is flagged as being “unusual”, and hence of possible importance. Because the described processes and systems work with deterministic, logical assertions, this kind of outlying occurrence can be determined and recorded.

Next, the discussion turns to FIG. 1 to illustrate the above described methods. FIG. 1 illustrates a small portion of a concept lattice 10 that is created in accordance with one embodiment of the present invention. Prior to creating the concept lattice 10, a collection of attributes and observations are obtained which form the relational data set, R. A database is created from the relational data set correlating the attributes and observations. The database is then analyzed to form the partial concept lattice 10 as shown in FIG. 1.

The partial concept lattice 10 is created as the relational data set is analyzed. Lattice 10 includes concepts 12, 14, 16, 18, 20, 22, 24, 26, and 28, each being denoted by letters which represent attributes. For example, concept 20 is denoted utilizing attributes adefgh. Closed attribute sets of concepts are connected by solid lines. For example, a solid line 44 connects the concepts 18 and 22 which contain closed attribute sets abdegh and abcdefgh, respectively. The attribute sets cg and bfg each represent minimal generators, 30 and 32, respectively, of the closed concept 22 (abcdefgh), and so correspond to the expression

$$\begin{matrix}( ∀ o ∈ O ) [ ( c ( o ) ⋀ g ( o ) ) ⋁ ( b ( o ) ⋀ f ( o ) ⋀ g ( o ) ) ] \\ \to ( a ( o ) ⋀ b ( o ) ⋀ c ( o ) ⋀ d ( o ) ⋀ e ( o ) ⋀ f ( o ) ⋀ g ( o ) ⋀ h ( o ) ) ,\end{matrix}$$

or more simply
cg [symbol] bfg→abcdefgh.

The collection of all concepts (attribute sets) whose closure is also abcdefgh, such as cge or bcfgh, is suggested by the dashed lines. Thus, ac and abf are minimal generators 34 and 36 respectively, of the closed concept abcdefh. Only the minimal generators 30, 32, 34, 36 of the two closed concepts abcdefgh and abcdefh are illustrated in FIG. 1.

A face of a closed set represents a difference between the closed set and a closed subset. For example, g=abcdefgh−abcdefh is one face 40 of concept 22 abcdefgh; while bc=abedefgh−adefgh and cf=abcdefgh−abdegh represent two other faces, 42 and 44 respectively, of concept 22. Each solid line between two closed concepts has been labeled with its corresponding face.Therefore, for any closed set, its collection of minimal generators and faces are mutual blockers, which simply means that each minimal generator has a non-empty intersection with each face, and vice versa.

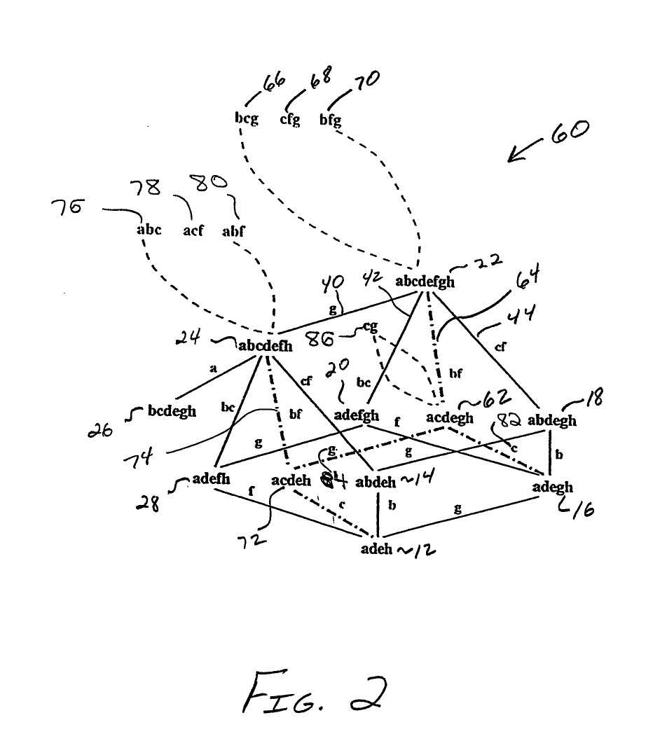

FIG. 2 shows a resulting lattice 60 after the entry of a new concept 62, or observation, or event, having attribute set acdegh, into concept lattice 10 (shown in FIG. 1). Concept lattices are sometimes denoted utilizing the notation, L. When the new concept 62 is first identified from the relational data set, the new concept 62 is entered into the lattice 60 at a particular location within the lattice 60.

Concept 22, having attributes abcdefgh is the smallest closed concept “covering” concept 62, which has attributes acdegh. The term “cover” or “covering” represents the smallest closed set with all of the attributes of another closed set plus at least one additional attribute. Concept 22 has attributes abcdefgh and represents the smallest closed set having all of the attributes of concept 62 (acdegh) plus at least one additional attribute. Thus, concept 62 is inserted in the position as shown in FIG. 2, and is covered by concept 22. Once the concept 62 is properly positioned in the lattice 60, the new faces and new minimal generators of the lattice 60 are determined. Since bf is a new face 64 of abcdefgh, its collection of minimal generators 66, 68, 70 is changed to {bcg, cfg, bfg} in order to preserve the necessary blocking property with the faces. Because at least one object, or event, has attributes acdefgh the logical expression describing concept lattice 60 changes to

$$\begin{matrix}( ∀ o ∈ O ) [ ( b ( o ) ⋀ c ( o ) ⋀ g ( o ) ) ⋁ ( c ( o ) ⋀ f ( o ) ⋀ g ( o ) ) ⋁ ( b ( o ) ⋀ f ( o ) ⋀ g ( o ) ) ] \\ \to ( a ( o ) ⋀ b ( o ) ⋀ c ( o ) ⋀ d ( o ) ⋀ e ( o ) ⋀ f ( o ) ⋀ g ( o ) ⋀ h ( o ) ) ] .\end{matrix}$$

The concepts, within lattice 60, that concept 62 intersect are those concepts having attributes less than concept 22. Concept 22 has attributes abcdefgh within lattice 60, while concept 62 has attributes acdegh. Thus, concept 62 intersects concepts 24, 20, and 18 having attributes abcdefh, adefgh and abdegh respectively. The intersection of concept 62 with the latter two concepts 20 and 18 is adegh which already exists in lattice 60 as concept 16. The intersection of concept 62 with abedefh is concept 72 having attributes acdeh, which is new and therefore recursively entered into lattice 60, thereby creating a new face 74 bf of concept 24, which has attributes abcdefh. After processing, minimal generators of concept 24 are determined to be minimal generators 76, 78, and 80 having attributes abc, acf, and abf respectively.

All of the faces of concept 62, with attributes acdegh, are now determined, to be face 82 with attribute c and face 84 with attribute g, so a single minimal generator 86 is cg, which is illustrated.

As is clear from the above described, the methods and system have an ability to update assertions about, and hence knowledge of, an observed world, on the fly. The assertions are updated using the relationship between generators and faces which is further described mathematically as follows:

Let F be any family of sets. A set B is said to be a blocker for F if ∀X∈F, B∩X≠0. The difference between a closed set Z and the closed sets Yᵢ, that it covers in a concept lattice L, are called faces Fᵢ of Z. In FIG. 2, the faces of concept 24 abcdefh are a, bc, bf and cf. The faces of Z, its generators and blockers are closely related as follows:

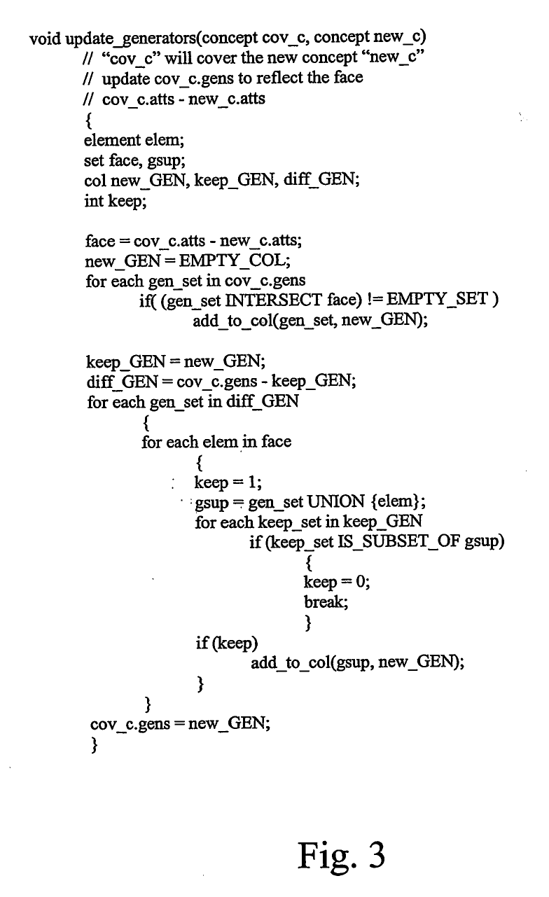

Let Z be closed and let Z.Γ={Z.γᵢ} be its family of minimal generators. If X⊂Z and X is closed, then Z-X is a blocker of Z.Γ. If B is a minimal blocker of Z.Γ, then Z-B is closed. Also, Z covers X in lattice L, if Z-X is a minimal blocker of Z.Γ. The interaction is illustrated above with respect to FIGS. 1 and 2. The process is also described by the pseudo program code in FIG. 3.

When a new concept, new_c is found to be covered by an existing concept, cov_c, the generators of cov_c are updated as illustrated by the pseudo code shown in FIG. 3. The generators of cov_c are updated, and the new concept, new_c, is intersected with all other children of the covering concept, cov_c. Generators of new_c are updated based on the intersection. If the intersection is not already in the lattice, the code recursively executes to create and insert the new concept.

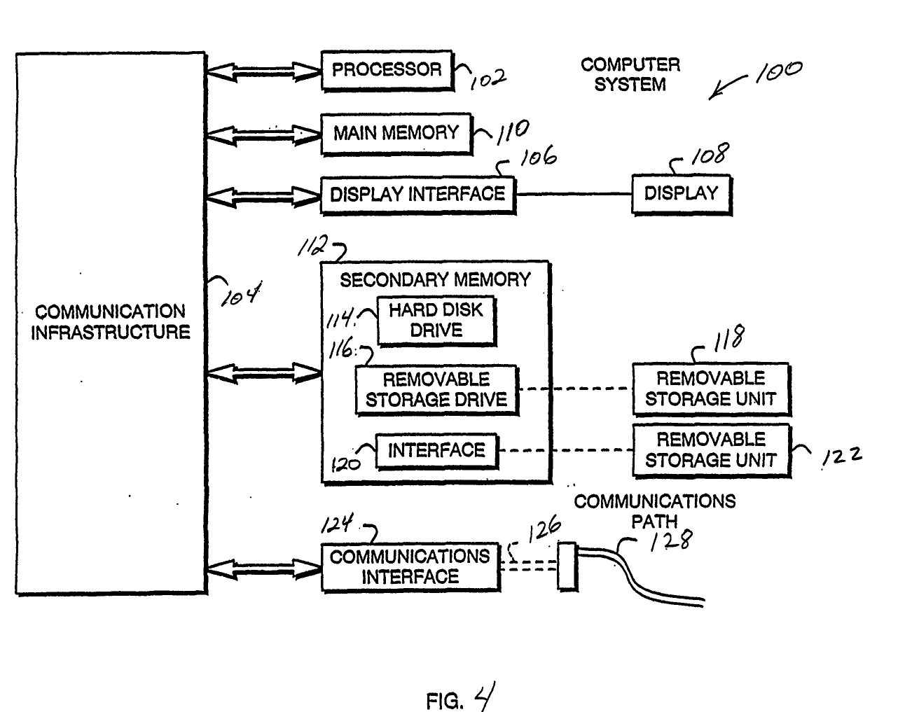

The method and apparatus of embodiments of the present invention may be implemented using hardware, software or a combination thereof and may be implemented in one or more computer systems or other processing systems, or partially performed in processing systems such as personal digital assistants (PDAs). An example embodiment of such a system is illustrated in FIG. 4.

FIG. 4 illustrates a general purpose computer 100 which includes one or more processors, such as processor 102. Processor 102 is connected to a communication infrastructure 104 (e.g., a communications bus, cross-over bar, or network).

Computer system 100 includes a display interface 106 that forwards graphics, text, and other data from the communication infrastructure 104 (or from a frame buffer not shown) for display on the display unit 108.

Computer system 100 also includes a main memory 110, preferably random access memory (RAM), and may also include a secondary memory 112. The secondary memory 112 may include, for example, a hard disk drive 114 and/or a removable storage drive 116, representing a floppy disk drive, a magnetic tape drive, an optical disk drive, etc. The removable storage drive 116 reads from and/or writes to a removable storage unit 118 in a well known manner. Removable storage unit 118, represents a floppy disk, magnetic tape, optical disk, etc. which is read by and written to by removable storage drive 116. As will be appreciated, the removable storage unit 118 includes a computer usable storage medium having stored therein computer software and/or data.

In alternative embodiments, secondary memory 112 may include other means for allowing computer programs or other instructions to be loaded into computer system 100. Such means may include, for example, an interface 120 and a removable storage unit 122. Examples of such removable storage units/interfaces include a program cartridge and cartridge interface (such as that found in video game devices), a removable memory chip (such as a ROM, PROM, EPROM or EEPROM) and associated socket, and other removable storage units 122 and interfaces 120 which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a PCMCIA slot and card, modem, etc. Software and data transferred via communications interface 124 are in the form of signals 126 which may be electronic, electromagnetic, optical or other signals capable of being received by communications interface 124. Signals 126 are provided to communications interface 124 via a communications path (i.e., channel) 128. Channel 128 carries signals 126 and may be implemented using wire or cable, fiber optics, a phone line, a cellular phone link, an RF link, an infrared link, and other communications channels.

In this document, the terms “computer program medium” and “computer usable medium” are used to generally refer to media such as removable storage drive 116, a hard disk installed in hard disk drive 114, and signals 126. These computer program products are means for providing software to computer system 100, which allows for the determination. The embodiments of the invention includes such computer program products. Computer programs (also called computer control logic) are stored in main memory 110 and/or secondary memory 112. Computer programs may also be received via communications interface 124. Such computer programs, when executed, enable computer system 100 to perform embodiments of the present invention as discussed herein. In particular, the computer programs, when executed, enable processor 102 to perform the functions of embodiments of the present invention. Accordingly, such computer programs represent controllers of computer system 100.

In an embodiment implemented using software, the software may be stored in a computer program product and loaded into computer system 100 using removable storage drive 116, hard drive 114 or communications interface 124. The control logic (software), when executed by the processor 102, causes the processor 102 to perform the functions as described herein.

In another embodiment, the invention is implemented primarily in hardware using, for example, hardware components such as application specific integrated circuits (ASICs).

In yet another embodiment, the invention is implemented using a combination of both hardware and software. In an example software embodiment of the invention, the methods described above may be implemented in various programming languages, such as Java, C⁺⁺, C—H—, Pascal, BASIC, FORTRAN, COBOL, and LISP, but could be implemented in other program languages.

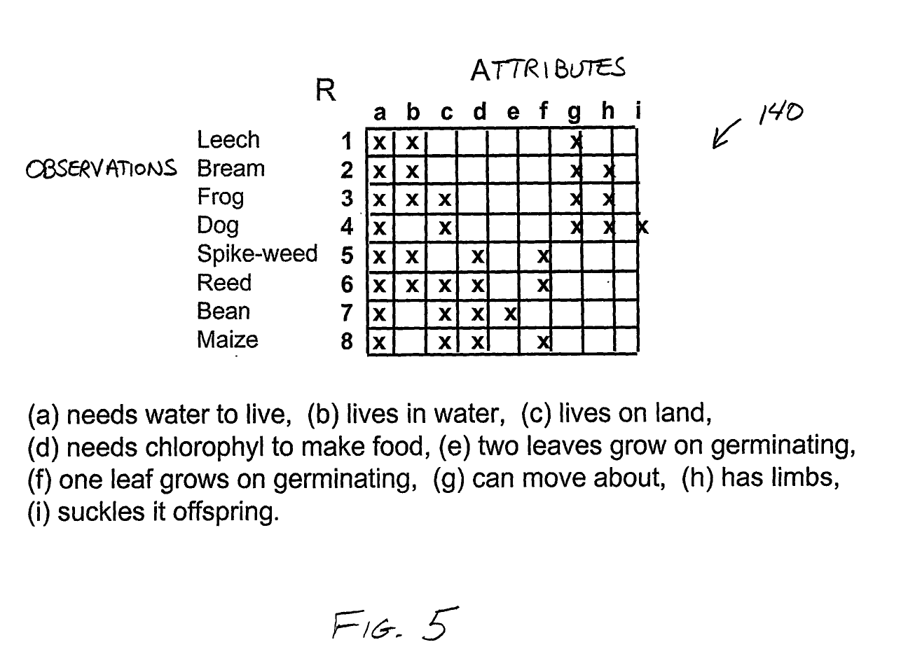

Next, an example is provided describing the operation of the computer system 100. FIG. 5 is a chart 140 illustrating relational data of attributes/columns and observations/rows regarding a small biological system. The attributes/columns shown include (a)needs water to live, (b)lives in water, (c)lives on land, (d)needs chlorophyll to make food, (e)two little leaves grow on germinating, (f)one little leaf grows on germinating, (g)can move about, (h)has limbs, and (i)suckles its offspring. The observations/rows shown include (1)leech, (2)bream, (3)frog, (4)dog, (5)spike-weed, (6)reed, (7)bean, and (8)maize. To further illustrate the example, an observation, a dog, found in row four of chart 140, needs water to live, lives on land, can move about, has limbs, and suckles it's young. Therefore, an observation of a dog, results in an attribute set of {acghi}. Chart 140 is therefore a representation of a number of objects (observations) having a binary relation R: (O; A) whose rows correspond to objects, or observations, and whose columns correspond to attributes. Chart 140 is further described as a small binary relation R from O={12345678} to A={abcdefghi}.

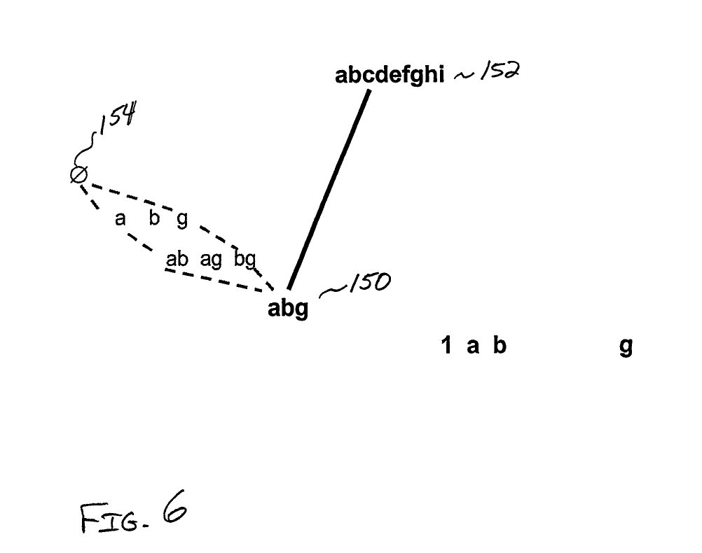

A concept lattice can be built utilizing objects or observations, for example, the observations of Chart 140. From the lattice, all causal dependencies between data items (attributes) will be identified, independent of frequency, utilizing logical assertions. In addition, generators of closed sets of attributes will be identified. FIG. 6 illustrates a first step in building such a concept lattice utilizing the above described attributes and observations of FIG. 5.

FIG. 6 illustrates an initial portion of a concept lattice that is built by the computer system 100 based on chart 140 in which a first observation or concept 150 having attributes abg is observed from the set of attributes abcdefghi of concept 152. Every observation in a concept lattice (which is a row signifying an observation in the example) is considered a closed set. Every additional observation is either in the concept lattice or is a new observation. The terms observation and concept are used interchangeably throughout. New observations may change the implications surrounding the new observation. When a new observation is observed from chart 140, a closest previous observation is found in the concept lattice already built. The new observation is inserted into the concept lattice under the closest covering concept or observation, as will be described in more detail. Utilizing such methodology, generators of the closed sets will be defined. Other terminology is defined for use in deriving the generators of the closed sets. For example, a face is a difference between a covered set, and the closed set which it covers. As the closed sets of the lattice are generated, from each new observation, minimal generators of the closed sets are determined and retained. By determining the minimal generators, all implications of the observations are encapsulated.

Therefore, a method of exploring all logical implications of attributes of interest based on a relational data set is provided. The method is based on information regarding attributes and observations being provided, preferably in a database which correlates the attributes and observation of the relational data (e.g., database 140). A lattice structure is formed and minimal generators and closed sets are identified based on the formed lattice structure, as is shown in the following description of the Figures.

Referring again to FIG. 6, the first observation or concept 150 of the relational data set has the attributes {abg}. The generator of {abg} is the empty set 154. As there has been only one observation at this point in the analysis any one of a, b, g, ab, ag, and bg will result in {abg}, which is first observation or concept 150. The set of attributes {abcdefghi} is said to cover the observation {abg}.

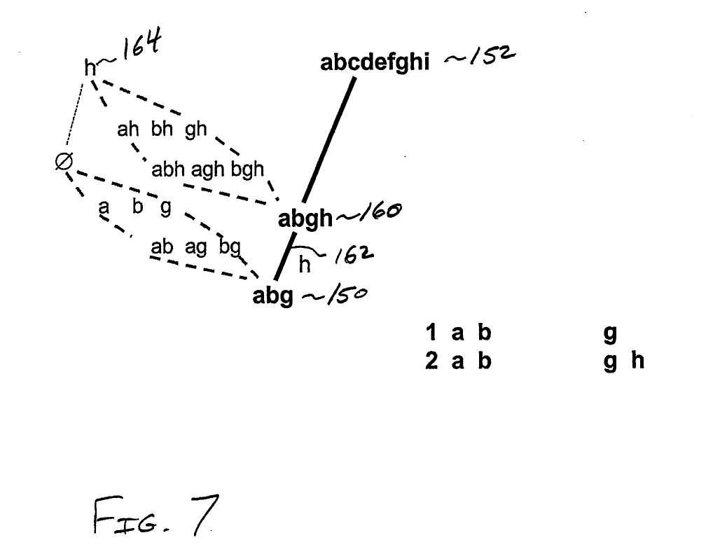

FIG. 7 illustrates the addition by the computer system 100 of a second observation 160 having a set of attributes {abgh}. The line 162 connecting first observation 152 to second observation 160 is described as a face of {abgh}, as attribute h is the difference between the closed set {abgh} and the closed set {abg}. Attribute h is also a minimal generator 164 of the second observation 160 {abgh}, as any instance of attribute h implies {abgh}, based on the two observations. Second observation 160 {abgh} is also said to cover first observation 150 {abg}, as second observation 160 has all of the attributes of first observation 150, plus at least one additional attribute.

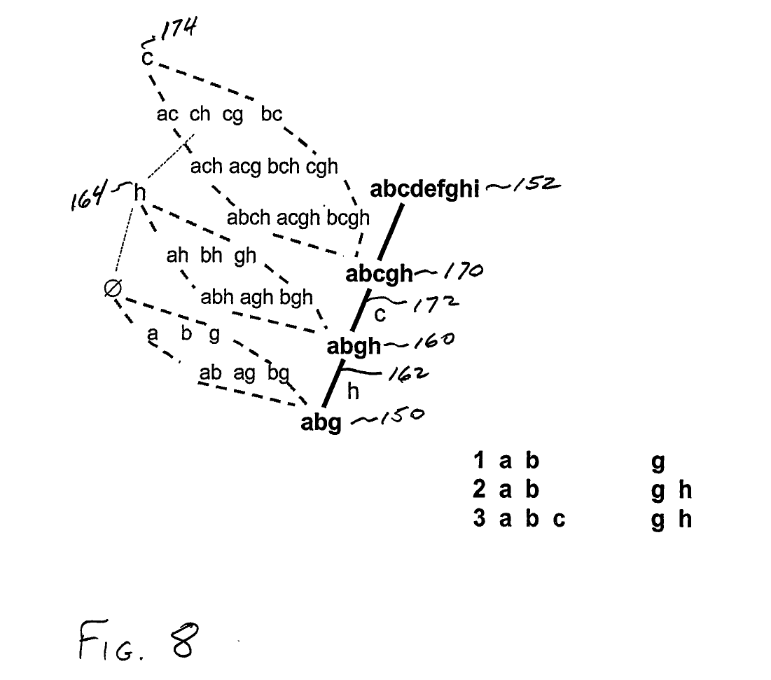

FIG. 8 illustrates the addition by the computer system 100 of a third observation 170 of the relational data set in database 140 to the lattice. Third observation 170 is the closed set {abcgh}. Line 172 is a face of {abcgh}, as c is the difference between the closed set {abcgh} and the closed set {abgh}. Attribute c is also a minimal generator 174 of {abcgh}. Third observation 170 {abcgh} is also said to cover second observation 160 {abgh}.

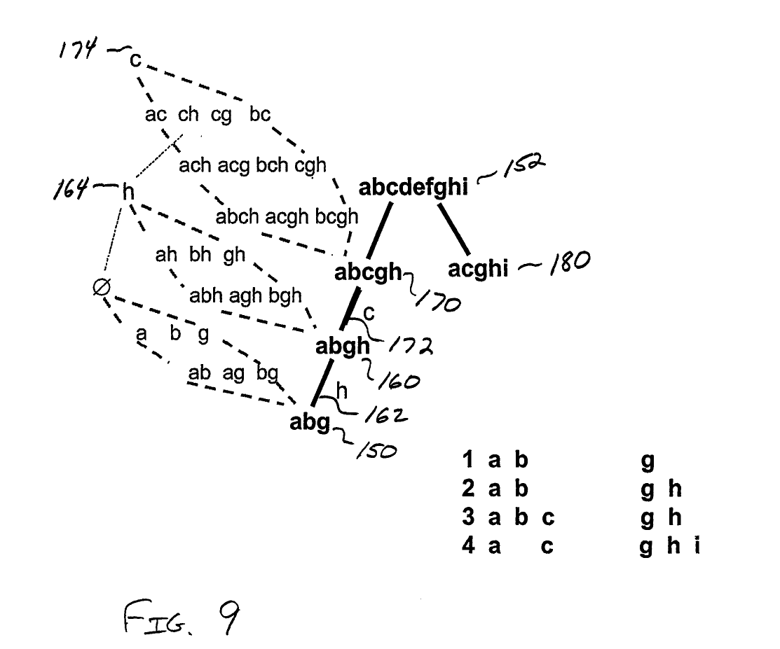

FIG. 9 illustrates the addition by the computer system 100 of a fourth observation 180 of the relational data set in database 140 to the lattice. The fourth observation 180 is the closed set {acghi}).

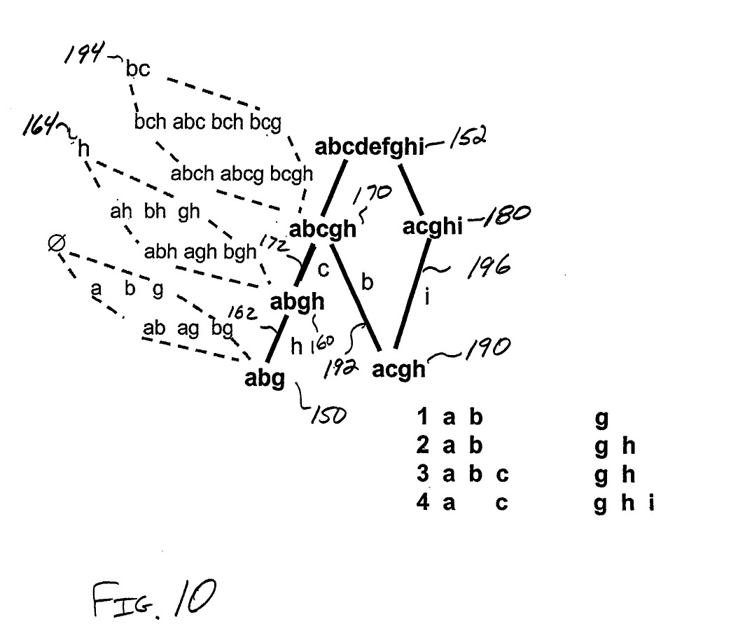

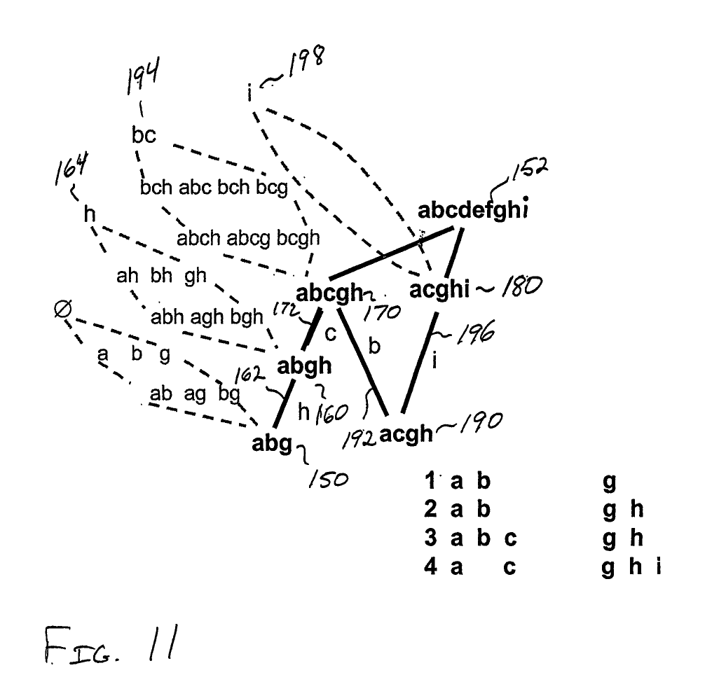

FIG. 10 illustrates an intersection 190 of fourth observation 180 with other elements (attributes), as intersection 190 is also a closed set. Intersection 190 includes the attributes {acgh}. Intersection 190 further causes a face 192 to be gener, as b is a generator of third observation 170 from intersection 190. Therefore a new minimal generator 194 of third observation 170 is generated, that is, bc, based on faces 172 and 192. Another face 196, labeled as i is generated, as the attribute i is a minimal generator of {acghi} (fourth observation 180) from intersection 190. The minimal generator 198 i, is shown in FIG. 11.

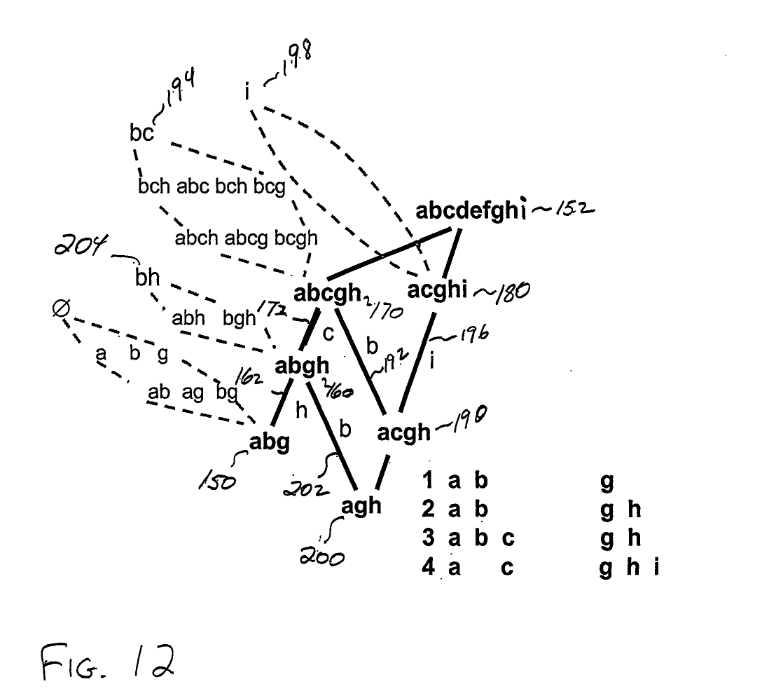

FIG. 12 illustrates an intersection 200 between intersection 190 and second observation 160. Intersection 200 includes the attributes {agh}. Intersection 200 results in a change to the generators of second observation 160, as face 202, labeled as b, is identified. bh is now a minimal generator 204 of second observation 160, as observation 160 has two faces 162 and 202, labeled as attributes h and b respectively. Face 206, labeled as c, indicates that c is a minimal generator 208 of intersection 190 which is not shown in FIG. 12.

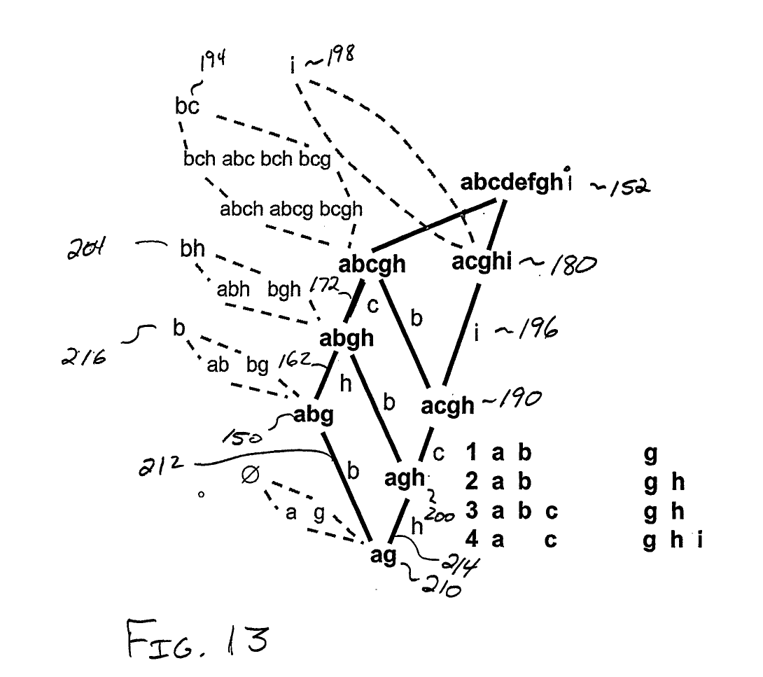

FIG. 13 illustrates a further intersection 210 of attributes. Specifically, intersection 210 includes attributes that are common to both first observation 150 and intersection 200. Intersection 210 includes attributes {ag}and results in face 212, labeled as b, and face 214, labeled as h. Identification of face 212 provides a minimal generator 216 for first observation 150, that is b implies observation {abg}.

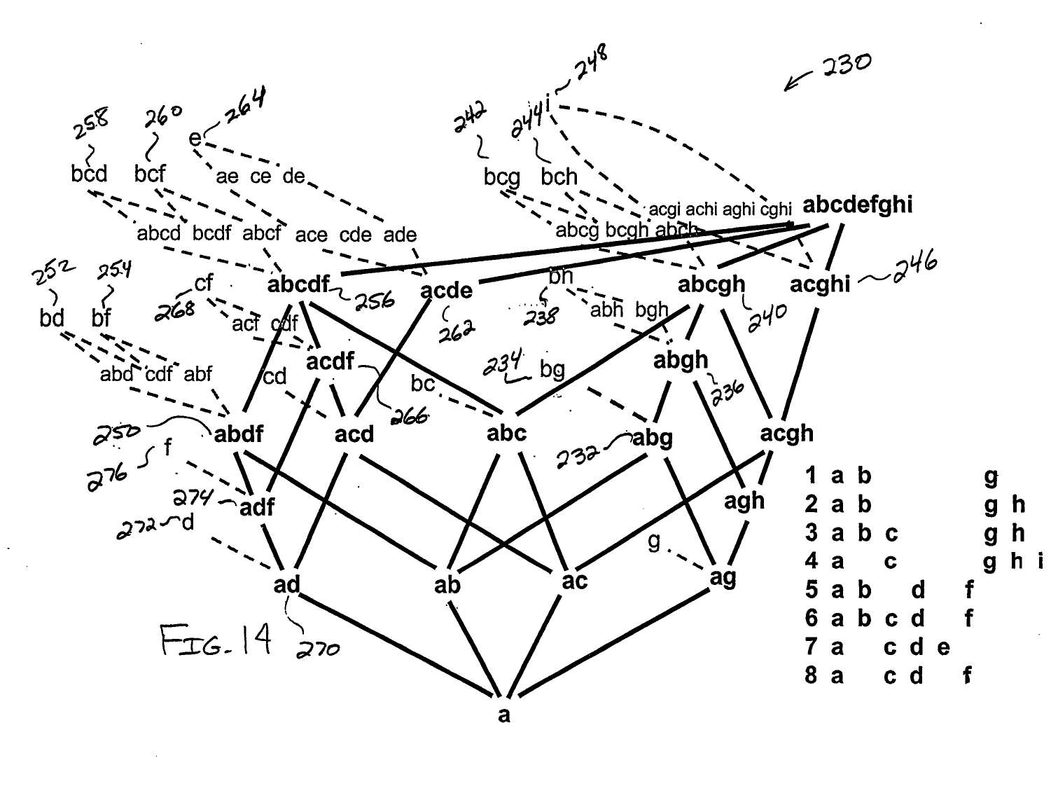

FIG. 14 illustrates a completed concept lattice 230 for all eight of the observations that were tabulated in FIG. 5. After complete analysis of the observations and the resulting intersection between attributes, as described above, all minimal generators to the observations are identified. Specifically, generator 234 {bg} is a minimal generator of observation 232 {abg}, generator 238 is a minimal generator of observation 236, and observation 240 has two minimal generators, generator 242 {bcg} and generator 244 {bch}. Continuing, observation 246 has a minimal generator 248 of {i}, observation 250 has minimal generators 252 {bd} and 254 {bf}, and observation 256 has minimal generators 258 {bcd} and 260 {bcf}. Finally the observation 262 has a minimal generator 264, consisting of attribute {e} and observation 266 has a minimal generator 268 of attributes {cf}.

It should be noted that minimal generators of intersections of attributes can also be identified, several of which are shown in FIG. 14. Two examples include intersection 270 which has a minimal generator 272 of {d} and intersection 274 which has a minimal generator 276 of {f}.

Logical implications result from the identification of minimal generators. For example, from minimal generator 238 which has attributes {bh}, representing an organism that lives in water and has limbs, based on the observations thus far it can be implied that the organism {a} needs water to live, and {g} can move about, which is observation 236. An example generator of an intersection, for example, generator 276 of intersection 274 implies that if one leaf grows upon germinating, the organism {a} needs water to live, and {d} needs chlorophyll to make food.

The identification of minimal generators for a set of relational data can be expressed mathematically as (∀o∈O)[(X(o)→Z(o)], which states that if X generates the closed set Z, then for all individual observations in the set of all observations, if the observation has properties X, then the observation must have properties Z. The mathematical implication given, illustrated by the above described observation 236, which implied that if the organism lives in water and has limbs, then the organism need water to live and can move about.

When compared to known batch processes which analyze the entire relational data set R, as required by known a priori methods, the incremental updating methods herein decrease processing times up to three orders of magnitude. Incremental lattice transformation makes concept lattices with minimal generator determination a practical knowledge discovery method.

To further illustrate the methods described herein, sometimes referred to as discrete, deterministic, data mining (DDDM), the well-known mushroom data set, obtained from the UCI Machine Learning Repository at http//wwwl.ics.uci.edu/mlearn/MLRepository.html was considered.

Many data mining experiments, using the mushroom data set, have been reported previously. Most have been concerned with the edibility of various mushrooms. The data set R consists of 8,124 observations of 42 nominal binary attributes. Attribute-0 has values “edible” and “poisonous”, denoted e0 and p0 respectively. For illustrative brevity, only the first nine attributes of the mushroom data set are listed below:

| | | |
|---|---|---|
| attr-0 | edibility: | e = edible, p = poisonous; |
| attr-1 | cap shape: | b = bell, c = conical, f = flat, k = knobbed, |
| | | s = sunken, x = convex; |
| attr-2 | cap surface: | f = fibrous, g = grooved, s = smooth, y = scaly; |
| attr-3 | cap color: | b = buff, c = cinnamon, e = red, g = gray, |
| | | n = brown, p = pink, r = green, u = purple, |
| | | w = white, y = yellow; |
| attr-4 | bruises: | t = bruises, f = doesn't bruise; |
| attr-5 | odor: | a = almond, c = creosote, f = foul, l = anise, |
| | | m = musty, n = none, p = pungent, s = spicy, |
| | | y = fishy; |
| attr-6 | gill attachment: | a = attached, d = descending, f = free, |
| | | n = notched; |
| attr-7 | gill spacing: | c = close, d = distant, w = crowded; |
| attr-8 | gill size: | b = broad, n = narrow. |

Because of multiple attribute values, the above listed attributes correspond to a binary array of 42 boolean attributes. The concept lattice generated by this 8,124×42 binary relation, R, consists of 2,640 concepts.

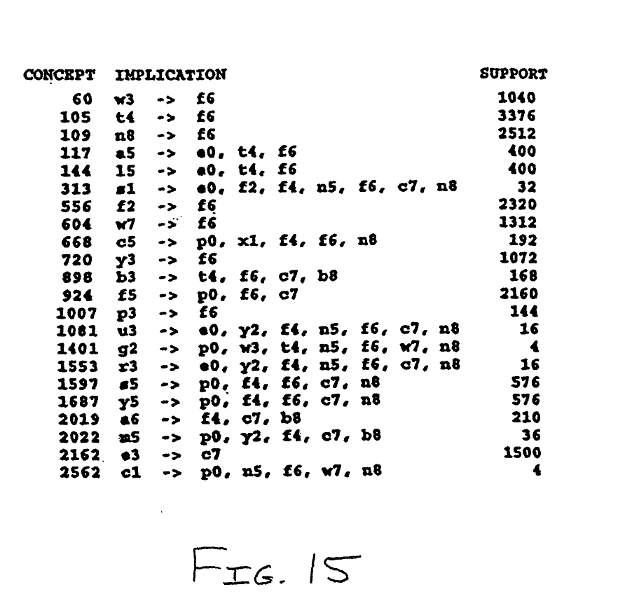

Implications with a single precedent are often the most important and are the easiest to apply in practice. Scanning the concept lattice generated by the binary relation, R, for single generators yields the 22 implications listed in FIG. 15, and it is seen that 12 of the implications have an attribute having to do with edibility, e0 or p0.

Support for each rule is listed at the right of FIG. 15. This is used in the statistical a priori approach. For example, to discover that mushrooms with “sunken” caps are edible, concept 313, a priori would require a significance threshold setting σ<0.004. Such a low σ value would suggest that the number of frequent sets would approach 2^{42-∈}, or possibly as many as 2⁴⁰=1.09×10¹², a number that can exhaust main memory in a processing system.

Virtually any data mining process would discover that “odor” is a crucial determinant in the mushroom data set. In particular, a “creosote”(#668), “foul”(#924), “musty”(#2022), “spicy”(#1597), or “fishy”(#1687) odor betokens “poisonous”. Since “almond”(#117) and “anise”(#144) indicate “edible”, only “no odor” is ambiguous. Such a mushroom can be “edible”(#313, #1081, #1553) or “poisonous”(#1401, #2562). There are only four conical capped instances and only four with grooved cap surfaces; but, although not frequent, eating any might be unpleasant.

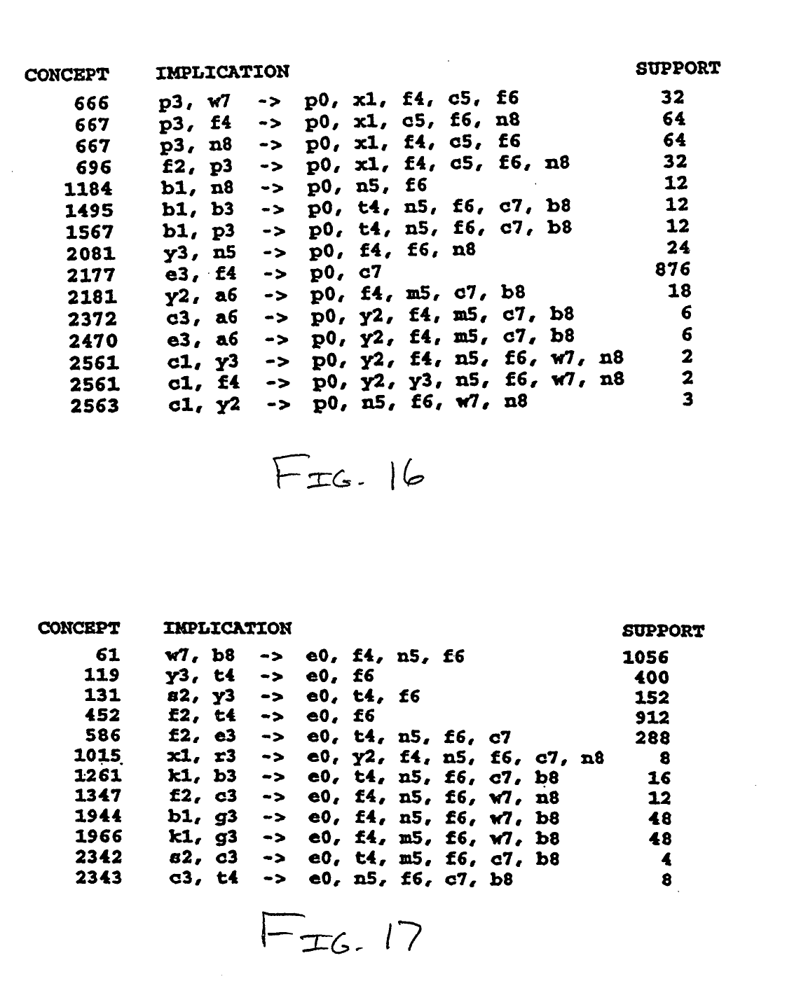

When analyzing the mushroom data utilizing the processes and systems of the present invention, and since “poisonous” is thought to be an important characteristic of mushrooms, the concept lattice was scanned for concepts which had p0 in the closed (consequent) set, and which had a two element generator not containing p0. There are 64 such implications. The 64 implication were passed through a filter, eliminating those whose generators included a poisonous odor, viz. c5, f5, m5, s5 or y5. The resulting 15 implications are shown in FIG. 16.

Seven of these instances could also be determined by odor, either c5 or m5. However, seven have “no odor” (n5) and would thereby be ambiguous in any case. In none of these extractions has the support played a role. DDDM implications are found independently of their frequency which is be desirable if one is considering tasting one of the 876 instances of “red” mushrooms that “don't bruise” easily. FIG. 17 illustrates the same kinds of logical criteria for edibility. FIGS. 16 and 17 both illustrate implications used to classify data, into either “edible” or “poisonous”.

Since DDDM yields implications that are universally quantified over the data set, logical transformations can be performed. Data errors should also be considered. Since it is not statistical, DDDM is not forgiving of erroneous input. If a new observation d would change the generators of a concept above a specified threshold, the system, for example, computer system 100 (shown in FIG. 5) can flag the observation and defer the insertion. The observation is then carefully examined for validity, and either discarded or reentered.

Creation of lattices of closed sets has been accomplished previously. However, until the methods and systems described herein were perfected, it was not possible to effectively create minimal generators of such lattices without an exhaustive search. The methods and systems described herein provide an iterative approach to the identification of generators of lattice of closed sets by identification of the generators based on an analysis of how each new observation in the generation of the lattice changes the generators of the surrounding observations.

Unlike standard data mining procedures which find statistical associations between data items based on frequency of occurrence, the systems and processes described herein find all causal dependencies between data items. The processes are discrete and deterministic and further are considered to be particularly valuable in scientific analysis and discovery protocols because all cause and effect type implications are uncovered, independent of the frequency of occurrence. In addition, the processes support all inferences with the observations that give rise to the inference, and additional observations can be incrementally added to the process without recomputing the entire lattice. The ability to incrementally add observations to the processes also provides computational efficiency. Tests have shown that the systems and processes described herein are particularly efficient at uncovering the significance of specimen properties, regardless of whether the specimens are biological, physical, or environmental.

The methods and apparatus for extracting logical implications, deterministic properties, and rare occurrences from relational data are useful in a variety of applications, all of which cannot be enumerated herein. By way of example only, the methods and/or apparatus may be useful in analyzing genetic databases, chemical compounds, and other materials, for example, in the development of new drugs and the like. In addition, the methods and apparatus may be useful in analyzing electronic circuits to identify and troubleshoot failures within such systems (e.g., aircraft electronics). Deterministic properties of mechanical devices are also determinable. For example, robotics systems may implement varied embodiments of the invention to control robotic mechanisms based on various sensory inputs, such as audio, video/visual, radar and the like.

While the invention has been described in terms of various specific embodiments, those skilled in the art will recognize that the invention can be practiced with modification within the spirit and scope of the claims.

1. A method for analyzing logical implications of attributes of interest based on a relational data set containing attributes and observations, R, said method comprising:
creating a database correlating the attributes and observations;
forming a lattice structure from the database;
identifying closed sets of attributes within the lattice structure; and
identifying attributes that are minimal generators of the closed sets of attributes.

2. A method according to claim 1 wherein forming a lattice structure comprises:
receiving a set of attributers constituting a new observation;
determining which previous observation is closest to the new observation; and
inserting the new observation into the lattice structure under the previous observation which is closest to the new observation.

3. A method according to claim 1 wherein identifying attributes that are minimal generators comprises identifying intersections between closed sets of attributes.

4. A method according to claim 1 further comprising identifying faces of the lattice structure, a face constituting a difference between connected closed sets within the lattice structure.

5. A method according to claim 1 further comprising identifying faces of the lattice, a face being defined as a difference between a covering set of attributes and a covered set of attributes within the lattice structure, a covering set of attributes defined as a set of attributes having all of the same attributes as the covered set, plus at least one additional attribute.

6. A method according to claim 1 wherein the identifying attributes that are minimal generators comprises premises of implication (∀o∈O)[(X(o)→Z(o)], which states that if X generates the closed set Z, then for all individual observations in the set of all observations, if the observation had properties X, then the observation must have properties Z.

7. A method according to claim 1 wherein the identifying closed sets of attributes within the lattice structure and identifying attributes that are minimal generators of the relational data for every additional observation added to the lattice structure.

8. A computer system comprising:
memory storing relational data, the relational data being a set of attributes and observations; and
a processor forming a lattice structure from the attributes and observations, identifying closed sets of attributes within the lattice structure, and identifying attributes that are minimal generators of the lattice structure.

9. A computer system according to claim 8, said memory comprising a database of the relational data.

10. A computer system according to claim 8 wherein to form the lattice structure, said processor receives an observation from said memory, determines which previously received observation is closest to the received observation, and inserts the observation into the lattice under the previously received observation which is closest to the received observation.

11. A computer system according to claim 8 further comprising an input device, said input device receiving new observations and forwarding those observations to said processor, said processor determining which previous observations are closest to the received observations, and inserting those observations into the lattice structure.

12. A computer system according to claim 8 wherein to identify attributes that are minimal generators, said processor identifies intersections between closed sets of attributes.

13. A computer system according to claim 8 wherein to identify attributes that are minimal generators, said processor identifies faces of the lattice structure, a face being defined as a difference between an attribute set having all of the same attributes as another attribute set, plus at least one additional attribute.

14. A computer system according to claim 8, said processor identifying attributes that are minimal generators according to (∀o∈O)[(X(o)→Z(o)], which states that if X generates the closed set Z, then for all individual observations in the set of all observations, if the observation had properties X, then the observation must have properties Z.

15. A computer system according to claim 8 further comprising an output unit outlining the minimal generators, the minimal generators being a set of logical implications of attributes identified as the minimal generators of the lattice structure.

16. A computer program embodied on a computer-readable medium for determining minimal generators of a lattice structure of relational data which includes observations and attributes of the observations, and determining changes to the minimal generators of the lattice structure resulting from iterative addition of observations to the relational data, comprising:
a lattice forming source code segment forming the lattice structure from the relational data, and incrementally changing the lattice structure based on each observation to be added to the lattice structure;
a set identification source code segment identifying closed sets of attributes from the observations within the lattice structure; and
a minimal generator identification source code segment identifying attributes that are minimal generators of the lattice structure.

17. A computer program embodied on a computer-readable medium according to claim 16 further comprising input source code for adding new observations into the lattice structure through said lattice forming code.

18. A computer program embodied on a computer-readable medium according to claim 16 wherein said set identification code identifies intersections between closed sets of attributes.

19. A computer program embodied on a computer-readable medium according to claim 16 wherein said minimal generator identification code identifies a difference between a covering set of attributes and a covered set of attributes within the lattice structure, a covering set of attributes being a set of attributes having all of the same attributes as the covered set, plus at least one additional attribute.

20. A computer program embodied on a computer-readable medium according to claim 16 wherein said minimal generator identification code identifies minimal generators of a set of relational data, R, according to (∀o∈O)[(X(o)→Z(o)], which states that if X generates the closed set Z, then for all individual observations in the set of all observations, if the observation had properties X, then the observation must have properties Z.

21. A computer program embodied on a computer-readable medium according to claim 16 wherein said lattice forming code determines which previous observation is closest to an observation and inserts the observation into the lattice under the previous observation which is closest to the observation.

22. A method for identifying causal dependencies between data items in a relational data set of observations and attributes of the observations, said method comprising:
determining intersections between the observations, the intersections and observations being closed sets of attributes;
forming logical implications based on the closed sets; and
determining changes to the implications based on changes to the intersections resulting from additional observations.
